(19) United States
(12) Patent Application Publication
(10) Pub. No.: US 2024/0357514 A1
(43) Pub. Date: Oct. 24, 2024

(54) ADJACENT CHANNEL INTERFERENCE MITIGATION IN CONCURRENT TRANSMISSIONS WITH PEER-TO-PEER ALLOCATION

(71) Applicant: Cisco Technology, Inc., San Jose, CA (US)

(72) Inventors: Pooya MONAJEMI, San Jose, CA (US); Vishal S. DESAI, San Jose, CA (US); Santosh B. KULKARNI, Sunnyvale, CA (US)

(21) Appl. No.: 18/303,245

(22) Filed: Apr. 19, 2023

(51) Int. Cl. H04W 52/24; H04W 52/36; H04W 52/38

(52) U.S. Cl. CPC H04W 52/243; H04W 52/367; H04W 52/383

(57) ABSTRACT

Systems and techniques for mitigating adjacent channel interference (ACI) in concurrent transmissions that include a peer-to-peer (P2P) resource unit assignment are described. An example technique includes determining that a downlink transmission from an access point to a first client station is subject to an amount of ACI from a P2P transmission from a second client station to a third client station. A set of mitigation actions is determined to reduce the amount of ACI to the downlink transmission, based at least in part on the amount of ACI. The set of mitigation actions are performed.

### TECHNICAL FIELD

Embodiments presented in this disclosure generally relate to wireless communications. More specifically, embodiments disclosed herein relate to techniques for mitigating adjacent channel interference (ACI) in concurrent transmissions that include a peer-to-peer resource unit assignment.

### BACKGROUND

Wireless communication standards, such as the Institute of Electrical and Electronics Engineers (IEEE) 802.11 technical standard, are continuing to evolve to meet the ever increasing demands of bandwidth intensive and low latency services, such as augmented/extended reality and cloud gaming. For example, recent amendments to IEEE 802.11 (e.g., IEEE 802.11be amendment) aim to introduce higher data rates using higher modulation orders, larger channel widths, and additional spatial streams, as well as a set of new features such as multi-link operation (MLO) and multi access point coordination (MAPC).

Additionally, the next generation of IEEE 802.11 (e.g., WiFi 8) aims to support aggregated physical layer protocol data units (APPDUs) (or A-PPDUs), which allows the concurrent transmission of multiple PPDUs by one or more devices to improve wireless performance in terms of throughput and latency. For example, in an APPDU, one or more PPDUs may occupy a primary channel and one or more other PPDUs may occupy a non-primary channel.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example wireless system, according to one embodiment.

FIG. 2 illustrates an example APPDU transmit opportunity, according to one embodiment.

FIG. 3 is a flowchart of an example method for mitigating ACI in concurrent transmissions that include a peer-to-peer resource unit assignment, according to one embodiment.

FIG. 4 illustrates an example frequency separation scheme for an APPDU transmit opportunity, according to one embodiment.

FIG. 5 illustrates an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method. The computer-implemented method includes determining that a downlink transmission from an access point (AP) to a first client station is subject to an amount of adjacent channel interference from a peer-to-peer transmission from a second client station to a third client station. The computer-implemented method also includes determining a set of mitigation actions to reduce the amount of adjacent channel interference to the downlink transmission, based at least in part on the amount of adjacent channel interference. The computer-implemented method further includes performing the set of mitigation actions.

Another embodiment described herein is a system. The system includes a memory and a processor communicatively coupled to the memory. The processor is configured to perform an operation. The operation includes determining that a downlink transmission from an access point (AP) to a first client station is subject to an amount of adjacent channel interference from a peer-to-peer transmission from a second client station to a third client station. The operation also includes determining a set of mitigation actions to reduce the amount of adjacent channel interference to the downlink transmission, based at least in part on the amount of adjacent channel interference. The operation further includes performing the set of mitigation actions.

Another embodiment described herein is a computer-readable storage medium. The computer-readable storage medium includes computer executable code, which when executed by one or more processors, performs an operation. The operation includes determining that a downlink transmission from an access point (AP) to a first client station is subject to an amount of adjacent channel interference from a peer-to-peer transmission from a second client station to a third client station. The operation also includes determining a set of mitigation actions to reduce the amount of adjacent channel interference to the downlink transmission, based at least in part on the amount of adjacent channel interference. The operation further includes performing the set of mitigation actions.

### Example Embodiments

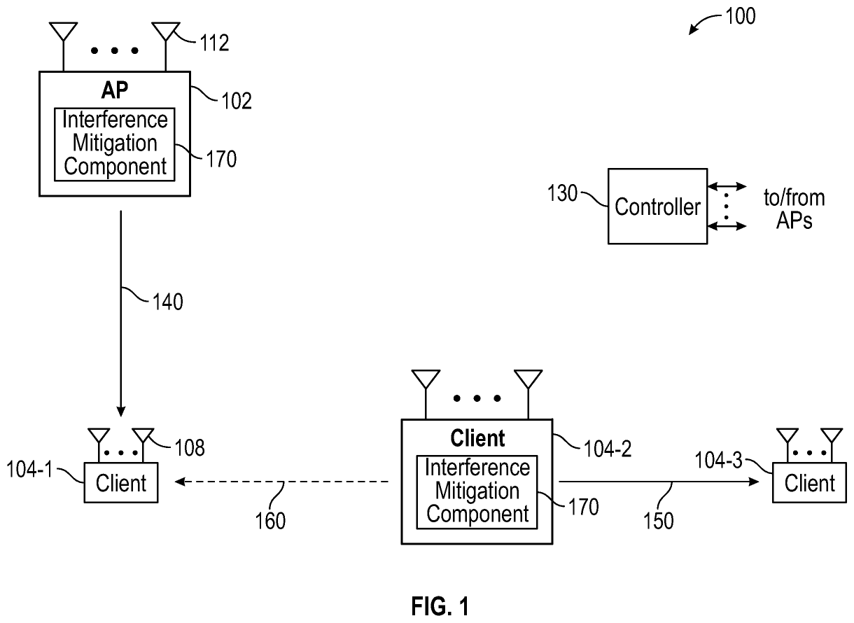

In certain wireless systems, the adjacent channel interference (ACI) from a peer-to-peer (P2P) transmission by a client station (STA) can impact the downlink reception at another client STA. Consider the example scenario in the wireless system 100 depicted in FIG. 1. Here, the AP 102 may send a downlink transmission 140 to client STA 104-1. However, the downlink transmission 140 from AP 102 may be impacted by the P2P transmission 150 from client STA 104-2 to client STA 104-3 in scenarios where the P2P transmission 150 and the downlink transmission 140 occupy the same APPDU.

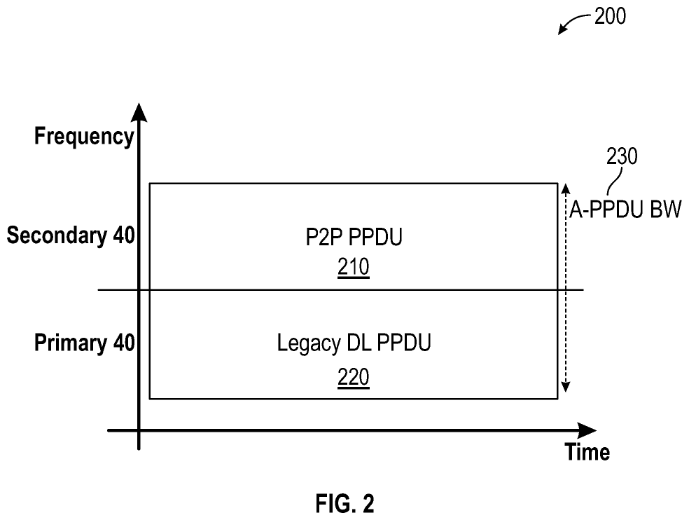

By way of illustration, in the example APPDU transmit opportunity (TXOP) 200 illustrated in FIG. 2, the APPDU bandwidth (BW) 230 extends across a primary (sub)-channel (e.g., primary 40 megahertz (MHz) channel) and a secondary (sub)-channel (e.g., secondary 40 MHz channel). Here, at least one PPDU 220 is reserved for legacy communications, such as the downlink transmission 140, on the primary channel of the APPDU BW 230 and at least one PPDU 210 is reserved for P2P communications, such as the P2P transmission 150, on the secondary channel of the APPDU BW 230. In this P2P scheme, however, ACI from multiple transmitters on (sub)-channels of the same bandwidth (e.g., APPDU BW 230) can severely impact the packet error rates (PERs) for downlink frames, such as the downlink transmission 140. As shown in FIG. 1, for example, the ACI 160 from the P2P transmission 150 can interfere with the downlink transmission 140.

To address this, embodiments provide systems, devices, and techniques for mitigating ACI in APPDU transmissions that include a P2P resource unit (RU) assignment. As described herein, embodiments provide a measurement framework that allows an AP (e.g., AP 102) to accurately measure and evaluate the impact of ACI from a P2P transmission. Based on the measured ACI, embodiments also provide a set of mitigation actions that can be employed by at least one of the AP or a (P2P transmitting) client STA to reduce the impact of the ACI on the downlink transmission. The set of mitigation actions can include, but are not limited to, frequency separation schemes for the APPDU and transmit power control mechanisms. In this manner, embodiments described herein can significantly reduce the ACI impact to downlink transmissions when downlink transmission and P2P transmissions occupy the same bandwidth of an APPDU.

Note, the techniques described herein for mitigating ACI in concurrent transmissions that include a P2P RU assignment may be incorporated into (such as implemented within or performed by) a variety of wired or wireless apparatuses (such as nodes). In some implementations, a node includes a wireless node. Such wireless nodes may provide, for example, connectivity to or for a network (such as a wide area network (WAN) such as the Internet or a cellular network) via a wired or wireless communication link. In some implementations, a wireless node may include an AP, a controller, or a client STA.

Referring again to FIG. 1, in certain embodiments, one or more techniques described herein for mitigating ACI in concurrent transmissions that include a P2P RU assignment may be implemented in the wireless system 100 depicted in FIG. 1. In particular, the AP 102 and/or one or more of the client STAs 104 1-3 may include an interference mitigation component 170, which is configured to implement one or more techniques described herein. The interference mitigation component 170 may include software, hardware, or combinations thereof. Note, the interference mitigation component 170 is described in greater detail herein.

In the wireless system 100, the AP 102 is generally a fixed station that communicates with client STA(s) 104 and may be referred to as a base station, wireless device, or some other terminology. The client STA 104 may be fixed or mobile and also may be referred to as a mobile STA, a client, a STA, a wireless device, or some other terminology. Note that while a single AP is depicted and a certain number of client STAs are depicted, the wireless system 100 may include any number of APs and client STAs.

As used herein, an AP along with the STAs associated with the AP (e.g., within the coverage area (or cell) of the AP) may be referred to as a basic service set (BSS). In some implementations, AP 102 may be the serving AP for client STA 104-1, client STA 104-2, and/or client STA 104-3. In some implementations, AP 102 may be the serving AP for client STA 104-1, and another AP (not shown) may be the serving AP for client STAs 104-2 and/or client STA 104-3. The AP 102 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA (e.g., client STA 104-2) may also communicate peer-to-peer with another client STA (e.g., client STA 104-3).

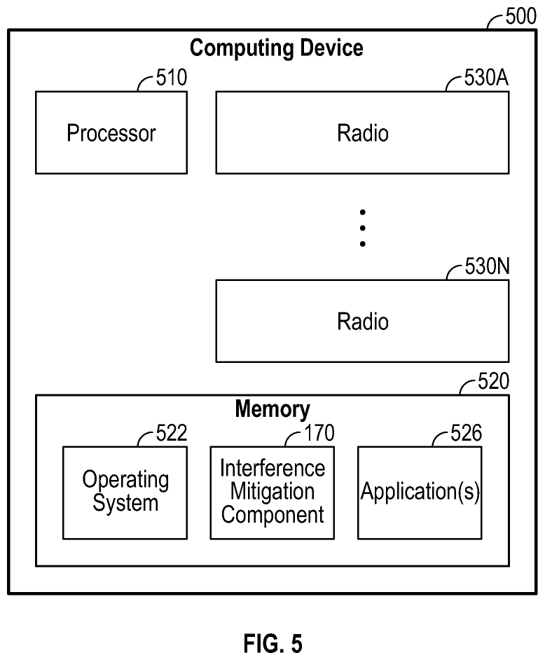

As shown in FIG. 1, each client STA 104 includes one or more radios 108. The client STA 104 can use one or more of the radios 108 to form links with an AP 102. As also shown, each AP 102 includes one or more radios 112 that the AP 102 can use to form links with one or more client STAs 104. In general, the AP(s) 102 and the client STA(s) 104 may form any suitable number of links for communication using any suitable frequencies. In some instances, a client STA 104 may form multiple links with a single AP 102. Example hardware that may be included in an AP 102 and a client STA 104 is discussed in greater detail in regard to FIG. 5.

The controller 130 couples to and provides coordination and control for the AP(s) 102. For example, the controller 130 may handle adjustments to RF power, channels, authentication, and security for the AP(s). The controller 130 may also coordinate the links formed by the client STA(s) 104 with the AP(s) 102. In some embodiments, the controller 130 is included within or integrated with an AP 102 and coordinates the links formed by that AP 102 (or otherwise provides control for that AP). For example, each AP 102 may include a controller that provides control for that AP. In some embodiments, the controller 130 is separate from the AP(s) 102 and provides control for those APs. In FIG. 1, for example, the controller 130 may communicate with the AP 102 via a (wired or wireless) backhaul. The AP(s) 102 may also communicate with one another, e.g., directly or indirectly via a wireless or wireline backhaul. Example hardware that may be included in a controller 130 is discussed in greater detail with regard to FIG. 5.

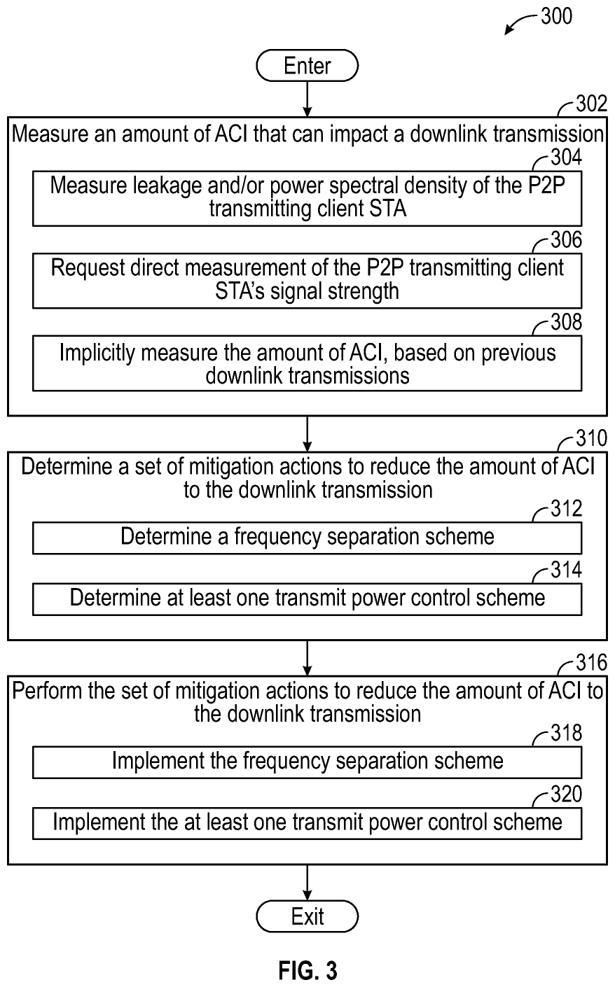

FIG. 3 is a flowchart of a method 300 for mitigating ACI in concurrent transmissions with a P2P RU assignment, according to one embodiment. The method 300 may be performed by an interference mitigation component (e.g., interference mitigation component 170).

Method 300 enters at block 302, where the interference mitigation component measures an amount of ACI that can impact a downlink transmission (e.g., downlink transmission 140). For example, the downlink transmission may occupy subchannels of the same bandwidth as a P2P transmission (e.g., P2P transmission 150), e.g., in an APPDU TXOP. The interference mitigation component may determine that the downlink transmission may be subject to ACI from the P2P transmission. Block 302 may include (sub)-blocks 304, 306, 308, or a combination thereof.

At (sub)-block 304, the interference mitigation component determines the amount of ACI that can impact the downlink transmission by measuring the leakage and/or power spectral density of the (P2P transmitting) client STA (e.g., client STA 104-2). For example, the AP (e.g., AP 102) (via the interference mitigation component) may perform such measurements on the (P2P transmitting) client STA's uplink frames on the same frequency bands as the AP's downlink transmission(s).

At (sub)-block 306, the interference mitigation component determines the amount of ACI that can impact the downlink transmission by requesting the direct measurement of the (P2P transmitting) client STA's signal strength from the intended recipient client STA (e.g., client STA 104-1) of the downlink transmission. For example, the AP (via the interference mitigation component) may request, from the client STA, the (P2P transmitting) client STA's received signal strength indicator (RSSI) as received by the intended recipient client STA.

At (sub)-block 308, the interference mitigation component determines the amount of ACI that can impact the downlink transmission by implicitly measuring the amount of ACI, based on the performance of previous transmissions. For example, the AP (via the interference mitigation component) may implicitly access the ACI impact by measuring the performance of previous downlink transmissions. For instance, client STAs, such as client STA 104-1, that are targets of downlink transmissions may implicitly attempt to derive ACI impact by measuring PERs during P2P transmissions in APPDUs. These client STAs can then report the assessments to the AP.

At block 310, the interference mitigation component determines a set of mitigation actions to reduce the amount of ACI to the downlink transmission. Block 310 may include (sub)-blocks 312, 314, or a combination thereof.

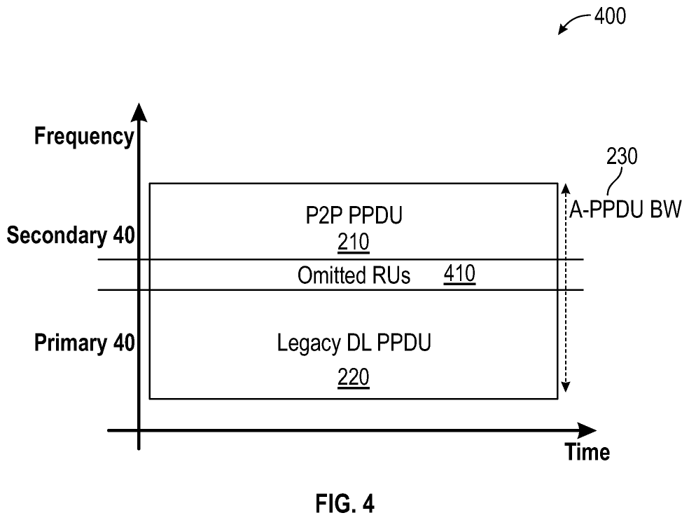

At (sub)-block 312, the interference mitigation component determines a frequency separation scheme as one of the set of mitigation actions. In one embodiment, determining the frequency separation scheme includes determining a number of RUs to omit from the APPDU. FIG. 4 illustrates an example frequency separation scheme 400, according to one embodiment. As shown, the frequency separation scheme 400 involves omitting a number of RUs 410 that lie near the edge between the DL PPDU 220 and P2P PPDU 210. In one embodiment, the width of the omitted RUs 410 can is set to a default value. In another embodiment, the width of the omitted RUs 410 is determined based on the amount of ACI measured in block 302. For example, the interference mitigation component can adjust the width of the omitted RUs 410 as a function of the measured ACI. In particular, the interference mitigation component can use the measurements of the (P2P transmitting) client STA's power spectral density, the (P2P transmitting) client STA's RSSI, or a combination thereof, to determine the measured ACI. The interference mitigation component can then optimize (e.g., reduce) the measured ACI to a target value by selecting a frequency distance, such that the total energy on the intended downlink RUs of the DL PPDU 220 is within a target limit.

Referring back to FIG. 3, at (sub)-block 314, the interference mitigation component determines at least one transmit power control scheme as one of the set of mitigation actions. In one embodiment, the at least one transmit power control scheme is determined based on the measured ACI in block 302, the width of the omitted RUs in block 312, or a combination thereof. In some embodiments, the interference mitigation component determines a transmit power control scheme for the (P2P transmitting) client STA (e.g., client STA 104-2) and another transmit power control scheme for the AP (e.g., AP 102).

In one embodiment, the transmit power control scheme for the (P2P transmitting) client STA involves setting a maximum transmit power for the (P2P transmitting) client STA to use for the P2P PPDU 210. The AP (via the interference mitigation component) may send an indication of the maximum transmit power to the (P2P transmitting) client STA using a frame (e.g., trigger frame) that precedes the APPDU transmission and that coordinates the PPDUs. The maximum transmit power control may be determined based on the measured ACI in block 302, one or more of the omitted RUs in block 312, or a combination thereof. For example, a wider range of omitted RUs may allow for a higher maximum transmit power limit. In another example, a higher signal strength (e.g., RSSI) of the P2P transmitting client STA that is measured by the intended recipient client STA of the downlink transmission may be associated with a lower maximum transmit power limit. In yet another example, a higher amount of leakage power in the P2P transmitting client STA's power spectral density may be associated with a lower maximum transmit power limit.

In one embodiment, the transmit power control scheme for the AP involves allowing the AP to use a higher transmit power to transmit the downlink PPDU 220. For example, in some case, the AP may have reduced the transmit power for the downlink PPDU 220, due to factors, such as radio resource management (RRM). Accordingly, in downlink APPDUs that include P2P RUs, the AP may increase its own transmission power to compensate for any ACI from the P2P transmissions.

At block 306, the interference mitigation component performs at least one of the set of mitigation actions to reduce the amount of ACI to the downlink transmission. Block 306 may include (sub)-blocks 318, 320, or a combination thereof.

At (sub)-block 318, the interference mitigation component implements the frequency separation scheme determined in (sub)-block 312. For example, the AP or controller (via the interference mitigation component) may omit the number of RUs 410 from the APPDU BW 230. In one embodiment, the RUs 410 may be omitted from the DL PPDU 220, the P2P PPDU 210, or a combination thereof.

At (sub)-block 320, the interference mitigation component implements the at least one transmit power control scheme. For example, the AP (via the interference mitigation component) may increase its transmission power (based on the determined transmit power in (sub)-block 314) to compensate for any ACI from the P2P transmissions. In another example, the (P2P transmitting) client STA (via the interference mitigation component) may limit its transmission power (based on the determined maximum transmission power limit in (sub)-block 314).

Note, in some embodiments, the transmit power control scheme and the frequency separation scheme are implemented as trade-offs. For example, in situations where power control is not feasible, a wider range of omitted RUs can be applied as part of the frequency separation scheme. Likewise, in situations where omitted RUs is not feasible, a lower maximum transmit power limit can be set for the (P2P transmitting) client STA and/or a higher allowed transmit power can be set for the AP.

FIG. 5 illustrates an example computing device 500, according to one embodiment. The computing device 500 can be configured to perform one or more techniques described herein for mitigating ACI in concurrent transmissions with a P2P RU assignment. For example, the computing device 500 can perform method 300 and any other techniques (or combination of techniques) described herein. The computing device 500 can be an AP (e.g., AP 102), a controller (e.g., controller 130), or a client STA (e.g., client STA 104). The computing device 500 includes a processor 510, a memory 520, and one or more radios 530a-n (generally, radio 530).

The processor 510 may be any processing element capable of performing the functions described herein. The processor 510 represents a single processor, multiple processors, a processor with multiple cores, and combinations thereof. The radios 530 facilitate communications between the computing device 500 and other devices. The radios 530 are representative of communication interfaces, such as wireless communications antennas and various wired communication ports. The memory 520 may be either volatile or non-volatile memory and may include RAM, flash, cache, disk drives, and other computer readable memory storage devices. Although shown as a single entity, the memory 520 may be divided into different memory storage elements such as RAM and one or more hard disk drives.

As shown, the memory 520 includes various instructions that are executable by the processor 510 to provide an operating system 522 to manage various functions of the computing device 500. The memory 520 also includes the interference mitigation component 170 that is configured to perform one or more techniques described herein, and one or more application(s) 526.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method comprising:
determining that a downlink transmission from an access point (AP) to a first client station is subject to an amount of adjacent channel interference from a peer-to-peer transmission from a second client station to a third client station;
determining a set of mitigation actions to reduce the amount of adjacent channel interference to the downlink transmission, based at least in part on the amount of adjacent channel interference; and
performing the set of mitigation actions.

2. The computer-implemented method of claim 1, wherein the downlink transmission and the peer-to-peer transmission are concurrent transmissions that occupy a same bandwidth of an aggregated physical layer protocol data unit (APPDU).

3. The computer-implemented method of claim 2, wherein:
the downlink transmission comprises a first physical layer protocol data unit (PPDU) that occupies a first set of resource units of the bandwidth of the APPDU; and
the peer-to-peer transmission comprises a second PPDU that occupies a second set of resource units of the bandwidth of the APPDU.

4. The computer-implemented method of claim 3, wherein the set of mitigation actions comprises at least one of a frequency separation scheme or one or more transmit power control schemes.

5. The computer-implemented method of claim 4, wherein the frequency separation scheme comprises a number of resource units omitted from the bandwidth of the APPDU.

6. The computer-implemented method of claim 5, wherein performing the set of mitigation actions comprises omitting the number of resource units from at least one of the first set of resource units or the second set of resource units.

7. The computer-implemented method of claim 4, wherein the one or more transmit power control schemes comprises at least one of (i) a maximum transmit power setting for the second client station or (ii) an allowed increase in a transmit power for the AP.

8. The computer-implemented method of claim 7, wherein performing the set of mitigation actions comprises transmitting, by the AP, the downlink transmission based on the allowed increase in the transmit power for the AP.

9. The computer-implemented method of claim 7, wherein performing the set of mitigation actions comprises transmitting, by the second client station, the peer-to-peer transmission based on the maximum transmit power setting for the second client station.

10. The computer-implemented method of claim 1, wherein determining that the downlink transmission is subject to the amount of adjacent channel interference comprises measuring at least one of a leakage power or a power spectral density of the second client station.

11. The computer-implemented method of claim 1, wherein determining that the downlink transmission is subject to the amount of adjacent channel interference comprises receiving an indication of a signal strength of the second client station from the first client station.

12. The computer-implemented method of claim 11, wherein determining that the downlink transmission is subject to the amount of adjacent channel interference comprises, prior to receiving the indication, transmitting a request to the first client station to measure the signal strength of the second client station.

13. The computer-implemented method of claim 1, wherein determining that the downlink transmission is subject to the amount of adjacent channel interference comprises implicitly measuring the amount of adjacent channel interference, based on one or more previous downlink transmissions.

14. The computer-implemented method of claim 13, wherein implicitly measuring the amount of adjacent channel interference comprises receiving an indication of one or more packet error rates for the one or more previous downlink transmissions.

15. A system comprising
a memory; and
a processor communicatively coupled to the memory, the processor being configured to perform an operation comprising:
determining that a downlink transmission from an access point (AP) to a first client station is subject to an amount of adjacent channel interference from a peer-to-peer transmission from a second client station to a third client station;
determining a set of mitigation actions to reduce the amount of adjacent channel interference to the downlink transmission, based at least in part on the amount of adjacent channel interference; and
performing the set of mitigation actions.

16. The system of claim 15, wherein the downlink transmission and the peer-to-peer transmission are concurrent transmissions that occupy a same bandwidth of an aggregated physical layer protocol data unit (APPDU).

17. The system of claim 16, wherein:
the downlink transmission comprises a first physical layer protocol data unit (PPDU) that occupies a first set of resource units of the bandwidth of the APPDU; and
the peer-to-peer transmission comprises a second PPDU that occupies a second set of resource units of the bandwidth of the APPDU.

18. A computer-readable storage medium comprising computer executable code, which when executed by one or more processors, performs an operation comprising:
determining that a downlink transmission from an access point (AP) to a first client station is subject to an amount of adjacent channel interference from a peer-to-peer transmission from a second client station to a third client station;
determining a set of mitigation actions to reduce the amount of adjacent channel interference to the downlink transmission, based at least in part on the amount of adjacent channel interference; and
performing the set of mitigation actions.

19. The computer-readable storage medium of claim 18, wherein the downlink transmission and the peer-to-peer transmission are concurrent transmissions that occupy a same bandwidth of an aggregated physical layer protocol data unit (APPDU).

20. The computer-readable storage medium of claim 19, wherein:
the downlink transmission comprises a first physical layer protocol data unit (PPDU) that occupies a first set of resource units of the bandwidth of the APPDU; and
the peer-to-peer transmission comprises a second PPDU that occupies a second set of resource units of the bandwidth of the APPDU.
